(19) United States
(12) Patent Application Publication
(10) Pub. No.: US 2004/0186831 A1
(43) Pub. Date: Sep. 23, 2004

(54) Search method and apparatus

(75) Inventors: Nobuyuki Hiratsuka, Kawasaki (JP); Hiroyuki Hatta, Kawasaki (JP); Isamu Watanabe, Kawasaki (JP); Kazunari Tanaka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/770,392

(22) Filed: Feb. 4, 2004

(30) Foreign Application Priority Data
Mar. 18, 2003 (JP) 2003-073484

(51) Int. Cl. G06F 7/00

(52) U.S. Cl. 707/3

(57) ABSTRACT

An object of this invention is to appropriately guide a user to obtain a more adequate search result. This invention comprises the steps of: specifying a search word (and/or phrase) included in a search condition designated by the user; obtaining evaluation data that is at least either of a score based on an appearance frequency and the number of documents to be searched that include the search word or its synonym, for each of the search word and its synonym; presenting the user with search word and its synonym and the corresponding evaluation data in a manner in which one or plurality of search words and its synonyms are selectable; and presenting the user with data concerning a document to be searched that includes the search word or its synonym selected by the user. Thus, it becomes possible to carry out a search processing using not only search word included in the search condition but also its synonym, and furthermore, because the evaluation data representing relevancy with the documents to be searched is presented to guide the user as to the selection of words, the retrieval adequate for the user is carried out.

### TECHNICAL FIELD OF THE INVENTION

This invention relates to search technology for document data.

### BACKGROUND OF THE INVENTION

In a conventional search system, it was ordinary that a search was carried out by designating search terms concerning a theme to be searched. For instance, in a search system of patent information, it is ordinary that the search is carried out using various terms such as “keywords”, “IPC”, “applicant”, and the like. However, such a search method has a problem in which thinking of effective search terms itself is know-how, and it is impossible to carry out an effective search if the searcher is not a skilled person to a certain extent.

Then, to solve the aforementioned problem, in the recent search system, it becomes possible for even a beginner to easily find out aimed documents by using a search method (hereafter, called “conceptual search”) in which the documents similar to sentences input by a user are retrieved, and the retrieved documents are arranged and displayed in order of similarities.

In this conceptual search, words and phrases are extracted from the sentences input by the user based on the morphological analysis, and a weight of the extracted word or phrase is calculated based on, for instance, the TF/IDF method, by using appearance frequencies of the extracted words and phrases in each document managed in the database, and appearance frequencies of the extracted words and phrases in the entire database, and the documents are sequentially arranged and displayed according to the weights.

In addition, JP-A-09-297766 discloses a similar document search apparatus as explained below. That is, it includes a keyword count unit for counting the number of keywords in an input document, which are recognized by a morphological analysis unit, keyword meaning class determining unit for categorizing keywords included in the document for each meaning class, meaning class evaluation value determining unit for assigning an evaluation value dependent on an importance degree according to the meaning class and the number of keywords belonging to each meaning class, and document similarity determining unit for assigning a similarity for each reference document based on the evaluation value.

Thus, by using the conceptual search, it becomes possible for even the beginner to relatively easily retrieve similar documents. However, in order to achieve the search accuracy more than a predetermined level, the accuracy of the input sentences, that is, the accuracy of words and phrases (extracted words and phrases) used in the calculation of the similarity becomes important. Therefore, when words and phrase that have different expression but the same meaning such as synonyms (hereafter, simply called “synonym”) are not taken into consideration, the search accuracy is lowered. For example, when only “freeway” is extracted, but “expressway” is not retrieved, the search accuracy is lowered. In addition, there is a case where the search result becomes discursive when words and phrases that do not directly influence the search theme are included. On the other hand, when words and phrases with too much influence are included, there is a case where the search result is biased.

In addition, as described in JP-A-09-297766, though there is a method to calculate an evaluation value dependent on the number of keywords belonging to the meaning class, because in this method, the importance degree is set for each meaning class to calculate the evaluation value, it is the premise that the meaning class is appropriate, and the importance degree for each meaning class is appropriately set. However, those settings cannot be always appropriate in all cases.

### SUMMARY OF THE INVENTION

Therefore, an object of this invention is to provide search processing technology to appropriately guide users in order to obtain an adequate search result.

A search method according to this invention comprises the steps of: specifying a search word (and/or phrase) included in a search condition from input data of the search condition designated by a user, and storing it into a storage device; obtaining evaluation data that is at least either of a score based on an appearance frequency and the number of documents to be searched that include the search word or its synonym, for each of the search word and its synonym, and storing it into the storage device; presenting the user with the search word and its synonym and the corresponding evaluation data in a manner in which one or plurality of search words and its synonyms are selectable; and presenting the user with data concerning a document to be searched that includes the search word or its synonym selected by the user.

By using such a method, it becomes possible to carry out a search processing using not only search word included in the search condition but also its synonym, and furthermore, because the evaluation data representing relevancy with the documents to be searched is presented to guide the user as to the selection of words, the retrieval adequate for the user is carried out.

Incidentally, the aforementioned obtaining step may comprise the steps of: extracting a synonym from the search word; and counting at least either of a number of documents to be searched that include the search word or its synonym and a first appearance frequency for each of the search word and its synonym by searching the documents to be searched by using the word and its synonym. The search and count may be carried out in advance as for each word, and the count result may be used.

Furthermore, the aforementioned obtaining step may further comprise the steps of: counting a second appearance frequency of the search word in a sentence input as the search condition; and calculating the score based on the appearance frequency by using the second appearance frequency and the first appearance frequency for each search word and its synonym. Thus, by using the first and second appearance frequencies, it is possible to derive the importance degree of the word from the relative relationship between the input sentence and the documents to be searched, and it becomes easy for the user to more adequately select the word.

Incidentally, the aforementioned method may be carried out by a combination of a program and computer hardware, and the aforementioned program is stored in a storage medium or storage device such as a flexible disk, CD-ROM, magneto-optical disk, semiconductor memory, and hard disk. Moreover, it may be distributed via a network as a digital signal. Incidentally, an intermediate processing result is temporarily stored into a storage device such as a main memory.

### BRIEF DESCRIPTION OF THE DRAWINGS

FIG. 1 is a functional block diagram in an embodiment of this invention;

FIG. 2 is a drawing showing a main processing flow in the embodiment of this invention;

FIG. 3 is a drawing showing an example of a search condition input screen;

FIG. 4 is a drawing showing an example of data stored in an extracted word file;

FIG. 5 is a drawing showing a processing flow of a processing for obtaining the number of documents including the extracted words and phrases and the score of the extracted words and phrases;

FIG. 6 is a drawing showing an example of data stored in a second extracted word file;

FIG. 7 is a drawing showing an example of data stored in a synonym file;

FIG. 8 is a drawing showing a processing flow of a threshold check processing;

FIG. 9 is a drawing showing an example of a threshold file;

FIG. 10 is a drawing showing an example of an extracted word selection screen; and

FIG. 11 is a drawing showing an example of a search result display screen.

### DETAILED DESCRIPTION OF THE PREFERRED EMBODIMENTS

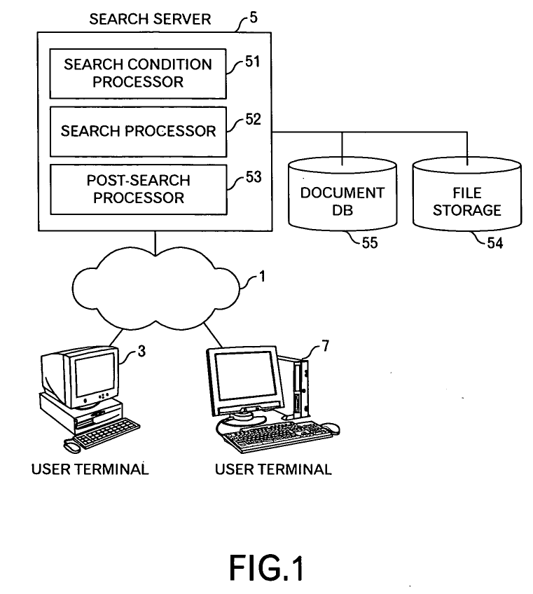

A system outline diagram in an embodiment of this invention is shown in FIG. 1. A network 1 such as the Internet and LAN (Local Area Network) is connected with user terminals 3 and 7 that are personal computers, for instance, and have a Web browser function, and a search server 5 that carries out a main processing in this embodiment and has a Web server function. The search server 5 includes a search condition processor 51, search processor 52, and post-search processor 53, and manages a file storage 54 and document database (DB) 55.

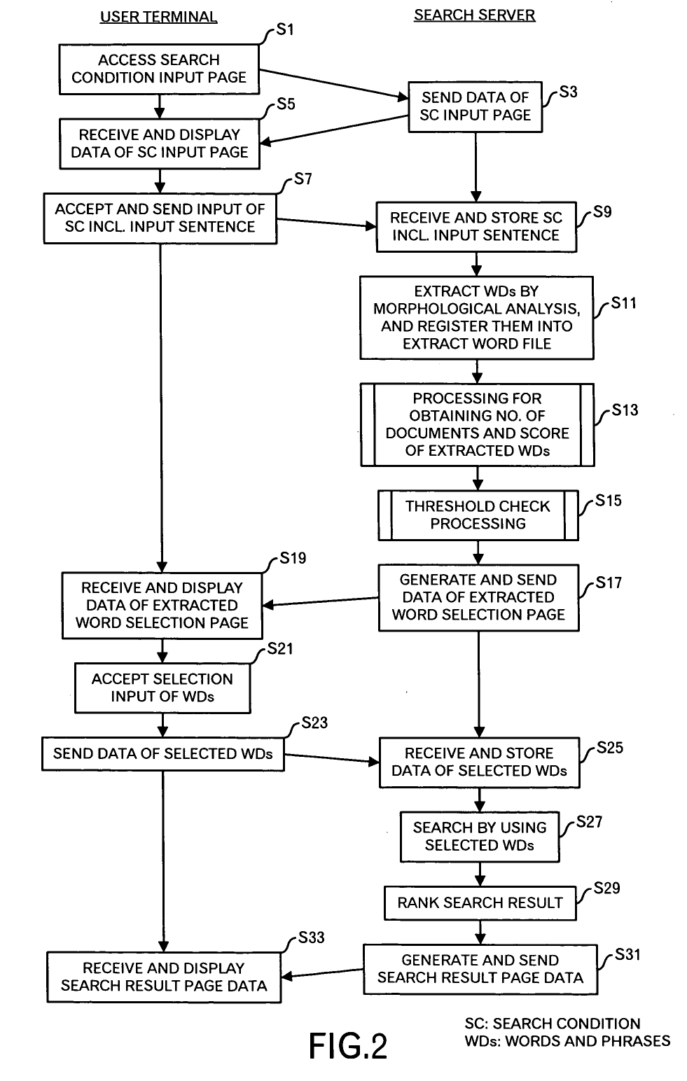

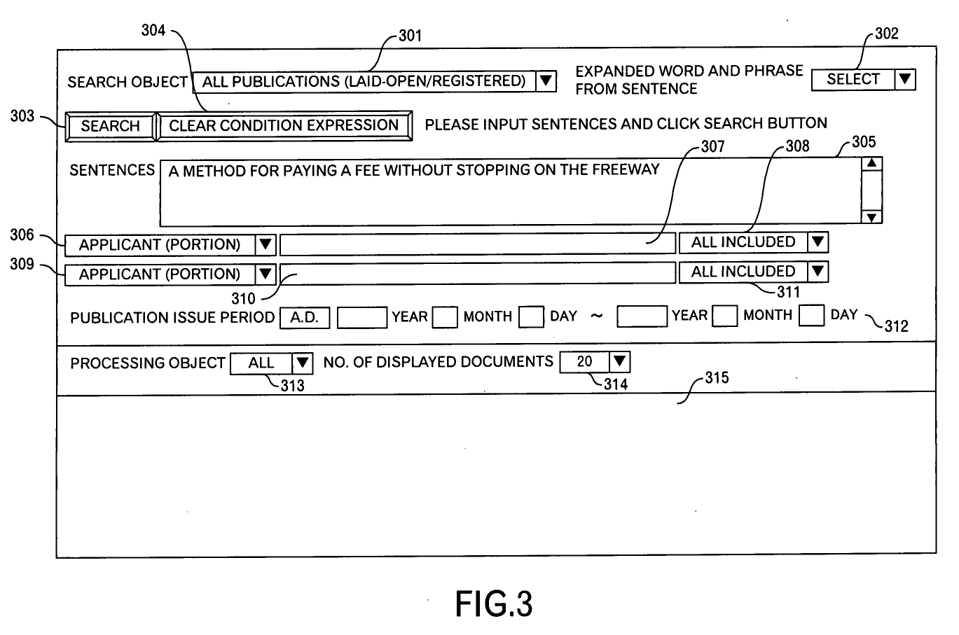

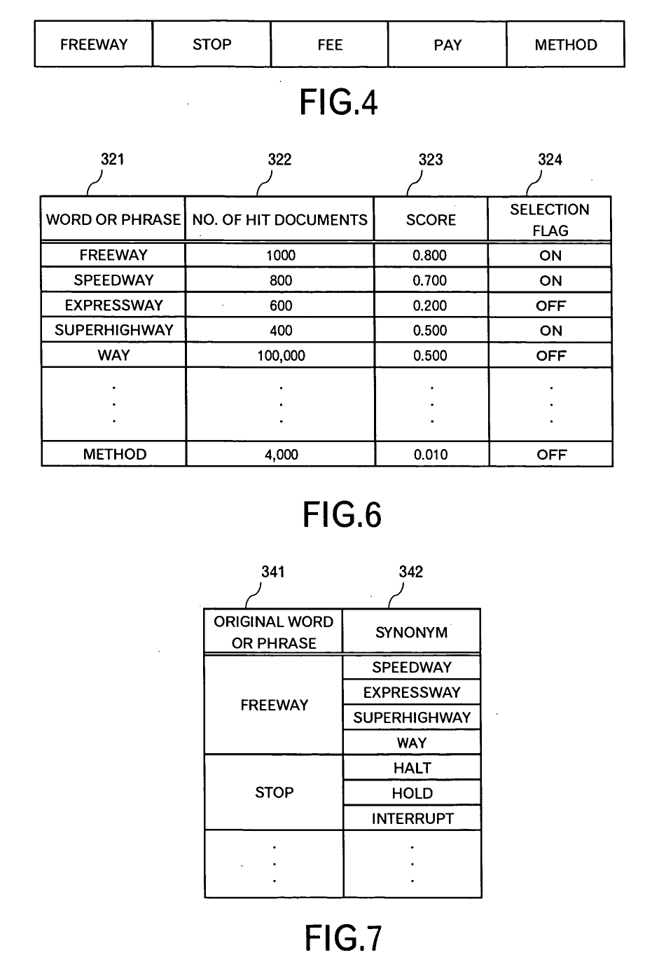

Processing contents of the system shown in FIG. 1 will be explained using FIGS. 2 to 11. A searcher operates a user terminal 3 to cause it to access a search condition input page (step S1). In response to the access from the user terminal 3, the search condition processor 51 of the search server 5 transmits data of the search condition input page to the user terminal 3 (step S3). The user terminal 3 receives the data of the search condition input page, and displays it on a display device (step S5). For example, a screen as shown in FIG. 3 is displayed.

FIG. 3 shows an example of the patent search. The screen includes a search object selection column 301 for selecting a search object such as all publications, publications of Laid-open applications, and publications of registered applications, a selection column 302 to carry out a selection input of whether or not the searcher selects synonyms in a case where the synonyms are expanded, search button 303, condition expression clear button 304 to clear the condition expression, sentence input column 305 to input sentences for the search, other search item designation columns 306 and 309, search keyword input columns 307 and 310 to input keywords for other search items, selection columns 308 and 311 to designate the relationship as to the search keywords, such as “all included”, and “either included”, designation column 312 for the publication issue period, processing object selection column 313 of the search result, selection column 314 of the number of displayed documents, and processing result display column 315.

The user watches the screen shown in FIG. 3, selects the search object, inputs a sentence (“a method for paying a fee without stopping on the freeway” in FIG. 3), selects other search items and relationship between search keywords, inputs search keywords, inputs a publication issue date, and then clicks the search button 303. It is possible to input only necessary data. The user terminal 3 accepts the input of the search condition including, for example, a sentence input by the searcher, and transmits the data to the search server 5 (step S7). The search condition processor 51 of the search server 5 receives the search condition including, for example, the input sentence from the user terminal 3, and temporarily stores it into a work memory area (area secured in a main memory or the like, for example) (step S9). The search condition processor 51 extracts words and phrases by carrying out the well-known morphological analysis for the input sentence, and registers the extracted data into an extracted word file in the file storage 54 (step S11). When the aforementioned sentence is input, words and phrases (extracted words and phrases), which include “freeway”, “stop”, “fee”, “pay”, and “method” are extracted and registered into the extracted word file.

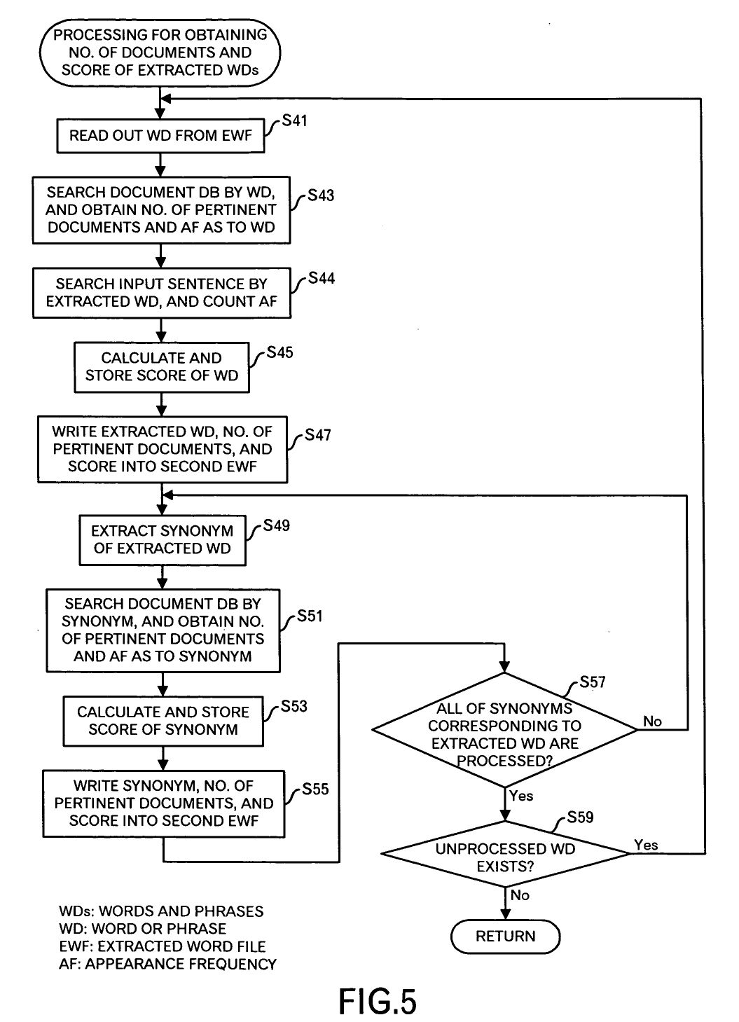

Then, the search condition processor 51 and search processor 52 carry out a processing for obtaining the number of documents including the extracted words and phrases and scores of the extracted words and phrases (step S13). As for this processing, the details will be explained using FIG. 5. First, the search condition processor 51 reads out an extracted word or phrase from the extracted word file (step S41). Then, the search processor 52 searches the document DB 55 by the extracted word or phrase, counts the number of pertinent documents in which the extracted word or phrase occurs and the appearance frequency of the extracted word or phrase, and temporarily stores them into the work memory area (step S43). Incidentally, it is possible that the document DB 55 are searched by each word or phrase in advance to count the number of pertinent documents and the appearance frequency, and the count result is read out at this step. In addition, it searches the input sentence by the extracted word or phrase, counts the appearance frequency, and temporarily stores the result into the work memory area (step S44). Then, the search condition processor 51 calculates a score of the extracted word or phrase, and stores it into the work memory area (step S45). The score of the word or phrase in this embodiment is calculated as follows:

((the appearance frequency of the extracted word or phrase in the input sentence)/(the appearance frequency of the extracted word or phrase in the document DB 55))

The search condition processor 51 writes the counted number of documents, and the calculated score into a second extracted word file in the file storage 54 so as to correspond to the extracted word or phrase (step S47)

An example of the second extracted word file is shown in FIG. 6. In the file configuration example of FIG. 6, values are input into a column 321 of the word or phrase, column 322 of the number of hit documents (i.e. the number of pertinent documents), column 323 of the score, and column 324 of a selection flag. At the step S47, values are registered into the column 321 of the word or phrase, column 322 of the number of hit documents, and column 323 of the score.

Then, the search condition processor 51 refers to a synonym file in the file storage 54, and extracts the synonym of the extracted word or phrase (step S49). As shown in FIG. 7, the synonym file includes a column 341 of the original word or phrase, and column 342 of the synonym, and one or plural synonyms are registered so as to correspond to a specific word or phrase (the original word or phrase). Therefore, the columns 341 of the original word or phrase are searched by the extracted word or phrase, and the corresponding words or phrases in the column 342 of the synonym are read out.

The search processor 52 searches the document DB 55 by one synonym, and counts the number of pertinent documents and the appearance frequency for the synonym (step S51). Incidentally, it is possible that the document DB 55 are searched by each word or phrase in advance to count the number of pertinent documents and the appearance frequency, and the counting result is read out at this step. In addition, it searches the input sentence by the synonym, counts the appearance frequency, and temporarily stores the result into the work memory area. Then, the search condition processor 51 calculates the score of the synonym, and stores it into the work memory area (step S53). The score of the synonym in this embodiment is calculated as follows:

((the appearance frequency of the synonym in the input sentence)/(the appearance frequency of the synonym in the document DB 55))

The search condition processor 51 writes the counted number of pertinent documents, and the calculated score into the second extracted word file (FIG. 6) so as to correspond to the synonym (step S55). At the step S55, values are registered in the column 321 of the word, column 322 of the number of hit documents, and column 323 of the score.

Then, it is judged whether or not all of the synonyms corresponding to the extracted word or phrase specified at the step S41 have been processed (step S57). If there is any unprocessed synonym, the processing returns to the step S49. On the other hand, if the processing for all of the synonyms is completed, the processing shifts to the step S59. Then, it is judged whether or not any unprocessed extracted word or phrase exists (step S59). If it is judged that any unprocessed extracted word or phrase exists, the processing returns to the step S41. When the processing for all of the extracted word or phrase is completed, the processing returns to the original processing.

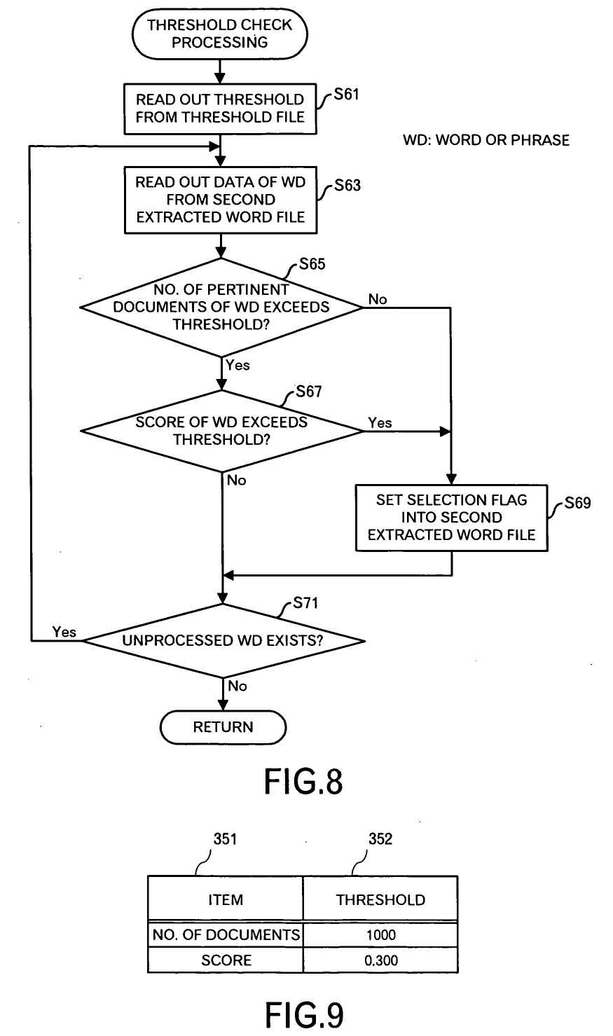

Returning to the explanation in FIG. 2, the search condition processor 51 carries out a threshold check processing in the file storage 54 (step S15). This threshold check processing will be explained using FIG. 8. The search condition processor 51 reads out a threshold from a threshold file (step S61). An example of the threshold file is shown in FIG. 9. In the file configuration example in FIG. 9, a column 351 of the item and column 352 of the threshold are provided, and the threshold (for example, 1000) as to the number of documents and threshold (for example, 0.300) as to the score are registered. Then, it reads out data for one word or phrase from the second extracted word file (step S63). It judges whether or not the number of pertinent documents for this word or phrase exceeds the threshold as to the number of documents (step S65). Because the search result becomes discursive when the number of pertinent documents for this word is large, the check is carried out at this step. In a case where the number of pertinent documents for this word or phrase is equal to or smaller than the threshold as to the number of documents, it sets the selection flag in the second extracted word file (step S69) In the example shown in FIG. 6, the corresponding flag in the column 324 of the selection flag is set to ON. Incidentally, the default value of the flag is “OFF”. Then, the processing shifts to the step S71.

On the other hand, in a case where the number of pertinent documents for this word or phrase exceeds the threshold as to the number of documents, it judges whether or not the score of this word or phrase exceeds the threshold as to the score (step S67). A case where the score is low includes a case where the appearance frequency of the word or phrase is high in the document DB 55, a case where the appearance frequency of the word or phrase is low in the input sentence, and both of them. On the other hand, a case where the score is high includes a case where the appearance frequency of the word or phrase is low in the document DB 55, a case where the appearance frequency of the word or phrase is high in the input sentence, and both of them. By such a score, it is possible to judge whether or not the word or phrase is distinctive in this search, or whether or not the importance degree of the word or phrase is high in this search. In this embodiment, because the importance degree or the like of the word or phrase is derived from the relative relationship between the input sentence and the document DB 55, not using the fixed importance and/or weight, it becomes possible to present the user with values more suitable for circumstances.

In the case where the score of this word or phrase exceeds the threshold as to the threshold, the processing shifts to the step S69. On the other hand, in a case where the score of this word or phrase is equal to or smaller than the threshold as to the score, it judges whether or not any unprocessed word or phrase exists in the second extracted word file (step S71). If there is an unprocessed word or phrase, the processing returns to the step S63. On the other hand, if the processing for all of the words and phrases is completed, the processing returns to the original processing.

Thus, the search server 5 automatically select recommended words and phrases to be used for the search to the searcher. Therefore, even if the searcher is a beginner, he or she can select adequate words and phrases.

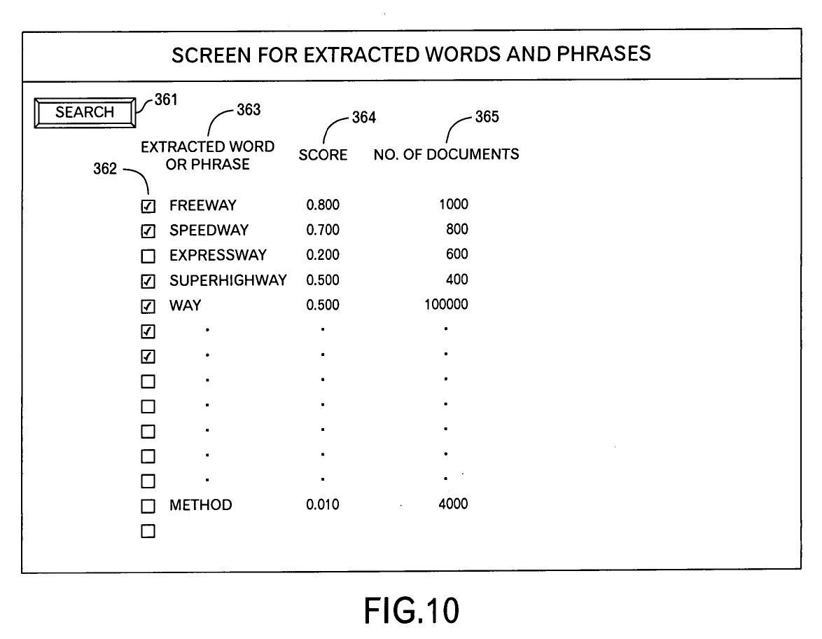

Returning to the processing of FIG. 2, the search condition processor 51 generates data of an extracted word selection page including data concerning the scores and the number of pertinent documents corresponding to the extracted words and phrase and their synonyms by using the second extracted word file (FIG. 6), and transmits it to the user terminal 3 (step S17). The user terminal 3 receives the data of the extracted word selection page from the search server 5, and displays it on the display device (step S19). For example, a screen as shown in FIG. 10 is displayed.

An example of FIG. 10 includes a search button 361, column 362 of the checkbox, column 363 of the extracted word or phrase, column 364 of the score, and column 365 of the number of documents. Incidentally, as for the words and phrases for which the flag is set in the column 324 of the selection flag in the second extracted word file, checks are set in the checkboxes at default. The searcher can remove the check and further set the check. Thus, in this embodiment, the guide is carried out so as to enable the searcher to carry out the adequate search by selecting adequate words and phrases based on the score and the number of documents.

The searcher refers to values of the score and the number of documents, and selects words and phrases for which the checks should be set and words and phrases for which the checks should be removed. Then, after the checks are set to the checkboxes and/or the checks are removed, he or she clicks the search button 351. The user terminal 3 accepts the selection input of the words and phrases (including the input to remove the checks) (step S21), and transmits data concerning the selected words and phrases to the search server 5 (step S23). The search processor 52 of the search server 5 receives the data concerning the selected words and phrases from the user terminal 3, and temporarily stores it into the work memory area (step S25). Then, it searches the document DB 55 by using the selected words and phrases (step S27). Incidentally, it is possible to maintain the result of the search that was carried out before and to read out it at this step. Furthermore, it is possible to hold the search result carried for each word or phrase, and to read out it at this step. Then, the post-search processor 53 calculates a score for each retrieved document, ranks them based on the scores, and temporarily stores the ranking result into the work memory area, for instance (step S29). In this embodiment, the score for the document is calculated by the total sum of the following calculation result as to the selected words and phrases:

((the appearance frequency of the word or phrase selected by the searcher in the document)/(the appearance frequency of the word or phrase selected by the searcher in the document DB 55))

The documents are ranked in descending order of the score value.

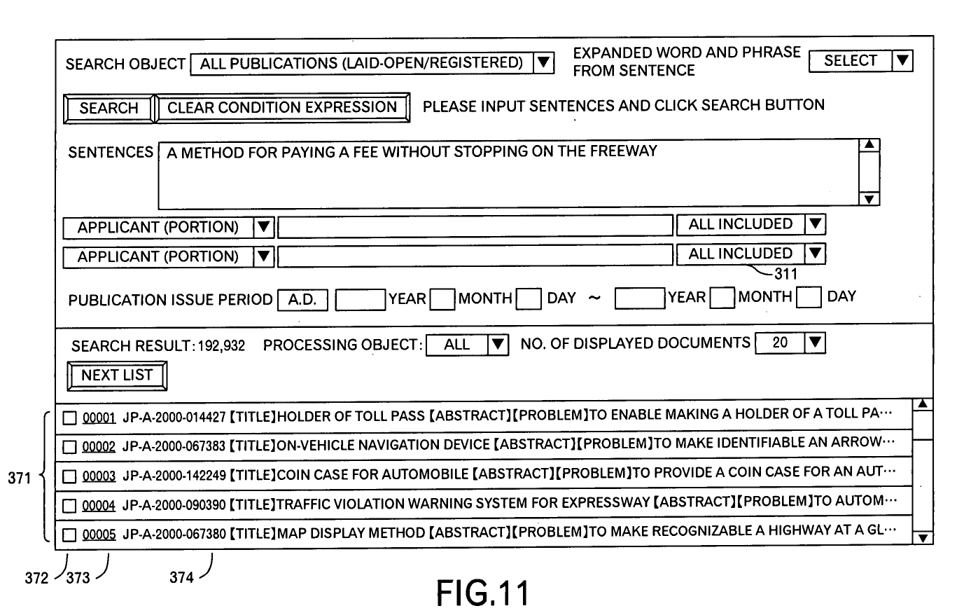

The post-search processor 53 generates a search result page data by using the ranking result, and transmits it to the user terminal 3 (step S31). The user terminal 3 receives the search result page data from the search server 5, and displays it on the display (step S33). A screen as shown in FIG. 11 is displayed.

In an example of FIG. 11, the processing result 371 is displayed on the processing result display column 315 in the screen shown in FIG. 3. The processing result 371 includes a column 372 of checkboxes to indicate the selection of the documents, column 373 of rankings, and column 374 of the document number and document contents. Thus, because the search result is presented in order of the documents whose relevancy with the input sentence is high, the user can easily specify the documents.

Though one embodiment of this invention was explained, this invention is not limited to this embodiment. For example, each functional block shown in FIG. 1 does not always correspond to an actual program module. Moreover, though one embodiment in the client-server environment was explained, it is possible to configure a terminal having functions of the search server 5, document DB 55 and file storage 57.

The score calculation method is also an example, and it is possible to calculate the score by other methods. Screen configurations shown in FIGS. 3, 10 and 11 are mere examples, and it is possible to adopt other screen configurations. In addition, the processing result may be displayed on another window. Furthermore, though an example of presenting the user with both of the score and the number of documents, it is possible to present the user with either of them.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A search method comprising:
specifying a search word included in a search condition designated by a user;
obtaining evaluation data that is at least either of a score based on an appearance frequency and a number of documents including said search word or its synonym, for each of said search word and its synonym;
presenting said user with said search word and its synonym and the corresponding evaluation data in a manner in which said search word or its synonym is selectable; and
presenting said user with data concerning a document including said search word or its synonym that was selected by said user.

2. The search method as set forth in claim 1, wherein said specifying comprises extracting a search word from a sentence input as said search condition by a morphological analysis.

3. The search method as set forth in claim 1, wherein said obtaining evaluation data comprises:
extracting a synonym from said search word; and
counting either of said number of documents including said search word or its synonym and a first appearance frequency of each of said search word and its synonym by searching documents by using said search word and its synonym.

4. The search method as set forth in claim 3, wherein said obtaining evaluation data further comprises:
counting a second appearance frequency of said search word in a sentence input as said search condition; and
calculating said score based on said appearance frequency by using said second appearance frequency of said search word and said first appearance frequency of each of said search word and its synonym.

5. The search method asset forth in claim 1, wherein said first presenting comprises:
judging whether or not said evaluation data of said search word and its synonym satisfies a predetermined condition; and
presenting said user with said search word or its synonym whose evaluation data satisfies said predetermined condition in a state indicating being pre-selected and said search word or its synonym whose evaluation data does not satisfy said predetermined condition in a state indicating being unselected.

6. The search method as set forth in claim 1, wherein said predetermined condition is a condition in which said number of documents including said search word or its synonym is lower than a first threshold, or a condition in which said score based on said appearance frequency for said search word or its synonym exceeds a second threshold.

7. The search method as set forth in claim 1, wherein said second presenting comprises:
counting a third appearance frequency of said search word or its synonym that was selected by said user, in said documents including said search word or its synonym that was selected by said user; and
presenting said user with said documents including said search word or its synonym that was selected by said user in order of values calculated by using said third appearance frequency.

8. A search program embodied on a medium, said search program comprising:
specifying a search word included in a search condition designated by a user;
obtaining evaluation data that is at least either of a score based on an appearance frequency and a number of documents including said search word or its synonym, for each of said search word and its synonym;
presenting said user with said search word and its synonym and the corresponding evaluation data in a manner in which said search word or its synonym is selectable; and
presenting said user with data concerning a document including said search word or its synonym that was selected by said user.

9. The search program as set forth in claim 8, wherein said specifying comprises extracting a search word from a sentence input as said search condition by a morphological analysis.

10. The search program as set forth in claim 8, wherein said obtaining evaluation data comprises:
extracting a synonym from said search word; and
counting either of said number of documents including said search word or its synonym and a first appearance frequency of each of said search word and its synonym by searching documents by using said search word and its synonym.

11. The search program as set forth in claim 10, wherein said obtaining evaluation data further comprises:
counting a second appearance frequency of said search word in a sentence input as said search condition; and
calculating said score based on said appearance frequency by using said second appearance frequency of said search word and said first appearance frequency of each of said search word and its synonym.

12. The search program as set forth in claim 8, wherein said first presenting comprises:
judging whether or not said evaluation data of said search word and its synonym satisfies a predetermined condition; and
presenting said user with said search word or its synonym whose evaluation data satisfies said predetermined condition in a state indicating being pre-selected and said search word or its synonym whose evaluation data does not satisfy said predetermined condition in a state indicating being unselected.

13. The search program as set forth in claim 8, wherein said predetermined condition is a condition in which said number of documents including said search word or its synonym is lower than a first threshold, or a condition in which said score based on said appearance frequency for said search word or its synonym exceeds a second threshold.

14. The search program as set forth in claim 8, wherein said second presenting comprises:
counting a third appearance frequency of said search word or its synonym that was selected by said user, in said documents including said search word or its synonym that was selected by said user; and
presenting said user with said documents including said search word or its synonym that was selected by said user in order of values calculated by using said third appearance frequency.

15. A search apparatus, comprising:
a specifier to specify a search word included in a search condition designated by a user;
an obtainer to obtain evaluation data that is at least either of a score based on an appearance frequency and a number of documents including said search word or its synonym, for each of said search word and its synonym;
a first indicator to present said user with said search word and its synonym and the corresponding evaluation data in a manner in which said search word or its synonym is selectable; and
a second indicator to present said user with data concerning a document including said search word or its synonym that was selected by said user.

16. The search method as set forth in claim 15, wherein said specifier comprises an extractor to extract a search word from a sentence input as said search condition by a morphological analysis.

17. The search method as set forth in claim 15, wherein said obtainer comprises:
an extractor to extract a synonym from said search word; and
a counter to count either of said number of documents including said search word or its synonym and a first appearance frequency of each of said search word and its synonym by searching documents by using said search word and its synonym.

18. The search method as set forth in claim 17, wherein said obtainer further comprises:
a second counter to count a second appearance frequency of said search word in a sentence input as said search condition; and
a calculator to calculate said score based on said appearance frequency by using said second appearance frequency of said search word and said first appearance frequency of each of said search word and its synonym.

19. The search method as set forth in claim 15, wherein said first indicator comprises:
a processor to judge whether or not said evaluation data of said search word and its synonym satisfies a predetermined condition; and
a indicator to present said user with said search word or its synonym whose evaluation data satisfies said predetermined condition in a state indicating being pre-selected and said search word or its synonym whose evaluation data does not satisfy said predetermined condition in a state indicating being unselected.

20. The search method as set forth in claim 15, wherein said predetermined condition is a condition in which said number of documents including said search word or its synonym is lower than a first threshold, or a condition in which said score based on said appearance frequency for said search word or its synonym exceeds a second threshold.

21. The search method as set forth in claim 15, wherein said second indicator comprises:
a counter to count a third appearance frequency of said search word or its synonym that was selected by said user, in said documents including said search word or its synonym that was selected by said user; and
an indicator to present said user with said documents including said search word or its synonym that was selected by said user in order of values calculated by using said third appearance frequency.
